(19) United States
(12) Patent Application Publication
(10) Pub. No.: US 2010/0247808 A1
(43) Pub. Date: Sep. 30, 2010

(54) Method for Depositing a Solute on a Metal Wire

(75) Inventors: Henri Hinc, Romagnat (FR); Guy Chevrel, Lezoux (FR)

Correspondence Address: COHEN, PONTANI, LIEBERMAN & PAVANE LLP, 551 FIFTH AVENUE, SUITE 1210, NEW YORK, NY, 10176, US

(73) Assignees: SOCIETE DE TECHNOLOGIE MICHELIN, Clermont-Ferrand (FR); Michelin Recherche et Technique S.A., Granges-Paccot (CH)

(21) Appl. No.: 12/665,931

(22) PCT Filed: Jun. 5, 2008
(86) PCT No.: PCT/EP2008/057022

§ 371 Date: Jun. 7, 2010

(30) Foreign Application Priority Data
Jun. 20, 2007 (FR) 0704450

(51) Int. Cl. H05B 6/02; B05D 7/20

(52) U.S. Cl. 427/591; 427/120

(57) ABSTRACT

A method of depositing a solute (34) on a metal thread (4), comprising the steps of: depositing a liquid solution (3), formed from a volatile solvent and said solute (34), on the thread (4); and then rapidly raising the temperature of the thread (4) to a temperature above the vaporization temperature of the solvent so as to vaporize the solvent placed in contact with the surface of said thread (4) and to form vapour bubbles (32) which, by expanding, generate a pressure pulse that ejects the liquid (33) remaining on the periphery of the thread.

The invention relates to the field of manufacturing metal cords and threads and more particularly to the step during which a treatment is carried out on these threads.

In many processes, it proves useful to deposit a layer of controlled thickness of a given substance on the surface of the thread so that, in a subsequent manufacturing step, the thread can be processed more easily.

This is the case for example when it is desired to use the thread as a fibre for reinforcing a material not having the required mechanical properties. It is then necessary to treat the thread so as to make it adhere perfectly to the matrix of the material in question, by depositing a coupling substance on the surface of the thread so as to make the cooperation between these two components as effective as possible. This type of application is widely used in the tyre industry or in the reinforced plastics industry.

In the context of the present description, the term “thread” should be understood in a very general sense, covering a monofilament, a multifilament, a cabled or folded yarn or an equivalent assemblage formed from a metal thread.

One of the methods of depositing a coupling substance on the thread consists in diluting or dissolving the treatment substance in a given solvent and then, in a first step of the treatment, in depositing the liquid on the surface of the thread and, in a second step, in removing the solvent by vaporizing it.

Very particular attention must therefore be paid to the precise amount of liquid deposited on the surface of the thread. It is in fact important to ensure that the liquid layer deposited, which generally has a small thickness, is as uniform as possible in order to ensure that the properties of the thread are uniform over its entire length.

For this purpose, the known techniques of wetting or coating consist in passing the thread through a liquid bath formed from a volatile solvent containing the solute that it is desired to deposit. By immersing the thread in the bath, the liquid solution is deposited thereon. The thread is then dried so as to extract the solvent, leaving the solute deposited on the thread. The drying step is carried out by supplying what is called “external” thermal energy, which is transmitted by radiation or by conduction from the heat source to the external surface of the liquid deposited on the thread and by conduction from the external surface of the liquid deposited on the thread to the interface between the thread and the liquid and then from the surface of the thread to the interior of the thread.

However, it turns out that controlled amount of liquid deposited on the thread may vary, for example because of variations in the rate at which the thread runs through the bath or a variation in the rheological characteristics of the solution.

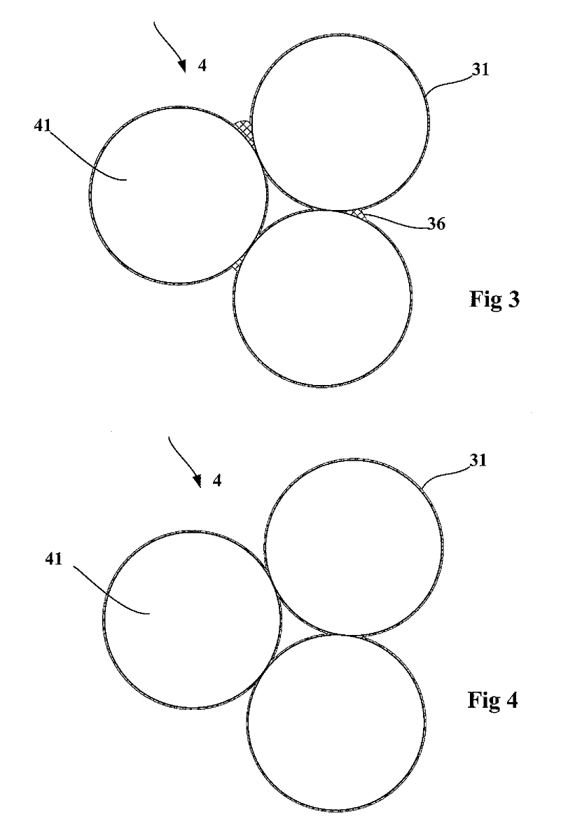

As a result of these variations, the amount of solute deposited on the thread varies proportionately to a greater or lesser extent. This is because, as the solvent progressively evaporates, because of the surface tension in the liquid and the curvature of the thread, the solute will concentrate in the areas where the solvent is still present, namely in the areas where the deposited liquid is thicker, such as the spaces between the individual filaments making up the thread, or the spaces within the cable yarns when the thread is made up of several folded yarns. When the thread is observed under a microscope, this reconcentration phenomenon results in localised menisci having a high solute concentration, for example within the cable yarns, and areas devoid of any coating, for example on the back of the threads. This phenomenon is illustrated schematically in FIG. 3, as will be seen later.

It follows that the appearance of a meniscus occurs essentially when the thread to be covered is made from an assemblage of at least two individual filaments.

The object of the invention is to provide a solution to this problem, namely to seek better uniformity of the coating deposited on the surface of the threads when the aim is to treat metal threads by depositing a film of solute on the surface thereof.

It has been demonstrated that, when the thread is made to run through a liquid bath and then the temperature of the thread is rapidly increased, the liquid deposited on its surface suddenly changes from the liquid phase to the gaseous phase. The solute left free by that portion of the solvent that has vaporized is then deposited on the surface of the thread, and the pressure wave formed by the vapour bubbles that develop on the surface of the thread ejects the excess liquid.

It has therefore been observed that the solute present on the surface of the thread is not carried away by the ejected liquid, that the amount of solute deposited corresponds substantially to that portion of the solute contained in the liquid which evaporated and that assaying can be carried out easily by measuring the amount of liquid recovered and the weight uptake of the thread.

According to the invention, the method of depositing a solute on a metal thread, is characterized in that it comprises the steps during which:

a liquid solution, formed from a volatile solvent and said solute, is deposited on the thread; and then the temperature of the thread is rapidly raised to a temperature above the vaporization temperature of the solvent so as to vaporize the solvent placed in contact with the surface of said thread and to form vapour bubbles which, by expanding, generate a pressure pulse that ejects the liquid remaining on the periphery of the thread.

The device for depositing a solute on a thread comprises means for running the thread through said device at a given rate, means for depositing a solution formed from a solvent and said solute, and heating means located downstream of the coating means. Said heating means comprises means capable of rapidly raising the temperature at the surface of the thread.

The energy delivered to the thread by the inductor is converted to thermal energy, this being transmitted to the liquid by conduction from the surface of the thread.

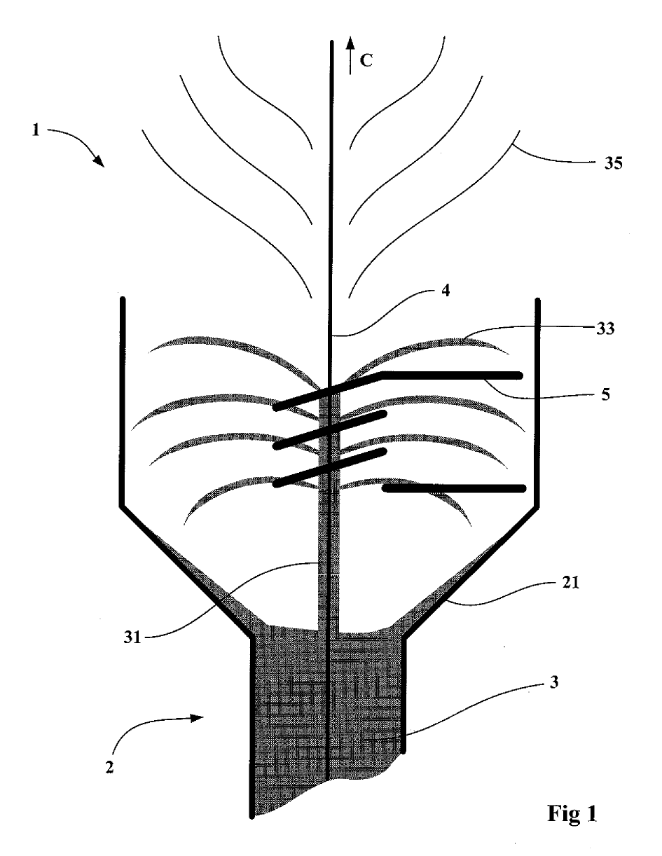

The purpose of the following description is to demonstrate the implementation of the invention based on one particular embodiment and on FIGS. 1 to 4, in which:

FIG. 1 shows a schematic view of a device according to the invention;

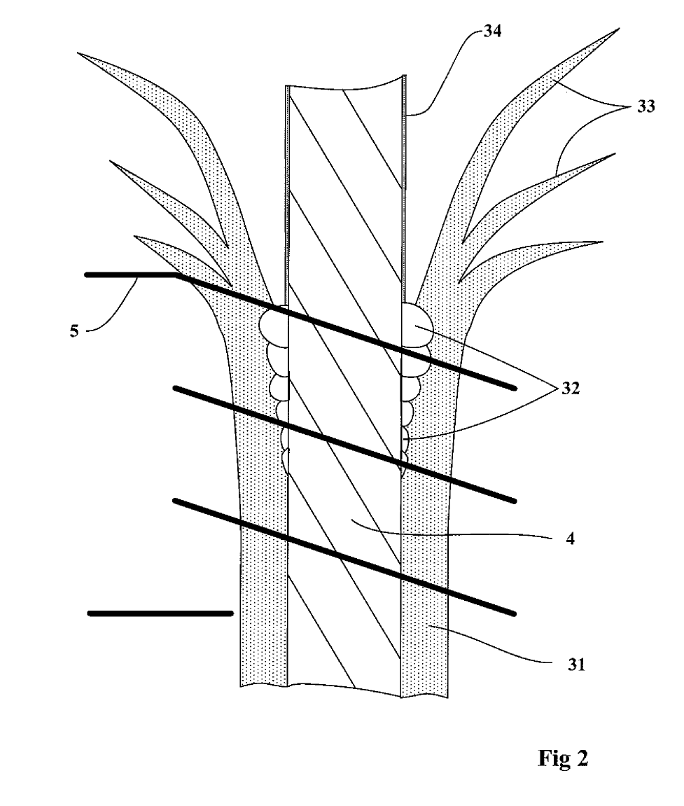

FIG. 2 shows a schematic view of the thread at the moment of vapour bubble formation and liquid ejection;

FIG. 3 shows a thread coated with a layer of solute, inter-filament menisci appearing on said thread; and

FIG. 4 shows a schematic view of a thread coated using a method according to the invention.

FIG. 1 shows a device 1 according to the invention, through which a thread 4 runs. Means (not shown) for running the thread advance said thread in the direction of the arrow C. As will be seen below, and according to the embodiment of the invention forming the subject of the present description, it is important for the thread to be a good electrical conductor and to be somewhat insensitive to rapid heating. As a result, in a first approach, the method and the use of the device are limited to metal threads.

The thread passes through a coating means 2 formed by a bath containing a liquid 3 composed of a solvent and a solute. The solute can be in ionic form or else in the form of an emulsion or a dispersion of particles.

By passing through the liquid bath, the thread is coated with a layer 31 of liquid 3. The coating method, known per se from the prior art, may comprise a bath through which the thread runs horizontally or by a vertical duct through which the liquid flows countercurrently with the run direction of the thread, as illustrated in FIG. 1.

On leaving the bath, the thread 4 passes through an inductor 5 through which an electric current flows. The inductor suddenly raises the thread to a temperature well above the vaporization temperature of the solvent. This has the effect, as illustrated in FIG. 2, of forming vapour bubbles 32 on the surface of the thread 4. The rapid growth of the vapour bubbles 32 results in the liquid 3 remaining on the periphery of the thread 4 being ejected in the form of splashes 33. A recovery system 21 is used to collect the excess liquid for the purpose of reusing it in the bath.

The power of the inductor 5 is regulated according to the run speed of the thread so as to obtain a surface temperature capable of generating the flash effect for ejecting the liquid from the surface of the thread. It is therefore possible to have a relatively short inductor so that the temperature rise at the surface of the thread is rapid. Moreover, because of the large current flowing through the inductor, the number of turns will also be small.

It is important for the bubbles 32 to form from the surface of the thread 4 so that the propulsive effect of the expanding vapour is maximised. Thus, the metallic nature of the thread, through which an induced current flows in that portion of the thread passing through the inductor 5, causes the thread to heat up much more rapidly than the liquid on the periphery thereof. The heat propagates into the liquid mainly by conduction from the surface of the thread to the liquid.

By regulating the power of the inductor or the run speed of the thread, it is therefore possible to modulate the solids content of the solute deposited on the surface of the thread. This is because it has been observed that the amount of solute deposited on the thread is approximately proportional to the amount of vapour generated during the expulsion phase for a given solute concentration in the solvent.

It follows that, the higher the power of the inductor, the more rapid and violent the bubble formation. Furthermore, by increasing the power dissipated by the inductor, or by slowing down the run speed of the thread, the amount of solids remaining on the surface of the thread on leaving the device is reduced. By increasing the power of the inductor, or by increasing the run speed of the thread, the ejection phenomenon is made less violent and it is necessary to vaporize, in the form of bubbles, a larger amount of solvent in order to eject all the liquid present on the surface of the thread. It follows that the amount of solute deposited on the thread increases.

However, care must be taken not to reduce the power of the inductor below a certain limit. This is because when the power is insufficient, the liquid is partially ejected, impairing the quality of the desired effect.

To improve ejection effectiveness, it is possible to bring the liquid in the bath to a temperature slightly below the vaporization temperature of the solvent so that the supply of energy from the inductor can serve directly for rapid vapour bubble formation. The term “slightly below” is understood to mean a temperature of 5° C. to 10° C. below the vaporization temperature of the solvent.

The device forming the subject of the present description also has the advantage of enabling the thread to run through the drying means without said thread coming into contact with said heating means 5. Thus, by judiciously placing the means for guiding the thread on leaving the device, it is possible to avoid any mechanical contact with the thread liable to damage the coating formed before the solvent has been completely removed.

On leaving the induction device, the surface of the thread 4 is practically free of liquid. Only a few traces of liquid, which have infiltrated into the internal structure of the thread, remain. It is then possible for the thread to be pulled and finally dried, thereby evaporating the last traces of solvent. The final drying step is carried out, if necessary, using known means (not shown) such as blowing a stream of dry air. In the general case, the temperature of the thread after the process is sufficient to cause, by thermal inertia, these traces of solvent 35 to evaporate.

The surface of the thread 4 is coated with a thin layer of solute 34 substantially corresponding, in terms of proportion of concentrations, to the amount of solvent evaporated. Thus, the amount of solute 34 deposited on the thread essentially depends on the concentration of the solute in the base liquid 3 and on the amount of vapour formed through the action of the inductor. This amount of vapour depends on the process control parameters, such as the run speed of the thread or the power of the inductor. The thickness of the film is approximately constant and uniform at all points on the surface of the thread, there being no localized overthicknesses such as menisci.

Finally, it has been observed that this method enables a relatively constant amount of solute to be deposited on the surface of the thread, irrespective of the amount of liquid carried away by the thread on entering the heating means. This is because, owing to the rapid formation of the vapour bubbles causing sudden ejection of the liquid, only that portion of the liquid in direct contact with the thread vaporizes. The propulsive effect of the vapour bubbles is sufficient to eject the remaining amount of liquid. It is thus possible to achieve a relatively uniform coating on the surface of the thread by regulating the amount of energy delivered to the thread.

In addition, the relative suddenness of the phenomenon prevents the concentration of the solute present on the surface of the thread and the formation of menisci, observed when the drying time is longer. In this way, the solute is distributed much more uniformly over the surface of the thread. The latter property is particularly important when the metal threads treated are intended for producing reinforcing fibres used in tyres. These threads are generally encapsulated in rubber and constitute reinforcing plies for the carcass or crown belt. It is therefore necessary to promote coupling between the metal threads and the rubber.

Moreover, it is known that this coupling is improved by depositing a thin layer of a silane-based composition on the thread. By improving the uniformity of the coating, the quality of the coupling, and consequently the strength of the tyre, are improved.

This type of coating enables the strength of adhesion of the thread to the rubber material in which said thread is encapsulated to be very substantially improved. These improved properties help to increase the strength of the reinforcing plies when used in a tyre, and also the resistance to penetration of oxidizing agents liable to corrode the thread and modify the strength thereof.

When a conventional method is used to deposit a silane, by running the thread through a bath comprising a water/silane solution and then drying the thread by running it through an oven in which external thermal energy is supplied, the silane coating has substantial localized overthicknesses. These overthicknesses, or menisci, may be 1 to 30 μm. FIG. 3 illustrates the case of a thread 4 formed by the assembly of three individual filaments 41 and recovered with a silane layer 31. Menisci 36 are visible in the spaces lying between the filaments.

The silane preferably has the following formula:

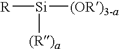

in which R represents an organic radical containing at least one functional group capable of reacting with at least the rubber composition in which the reinforcement is encapsulated. Each OR′ represents a group capable of reacting with an oxide or a hydroxide on the surface of the steel; each R″ represents, independently, hydrogen, a cyclic or acyclic organic radical or a halogen; and a may take a zero value or a value at most equal to 2.

The radical R preferably carries a hydroxyalkyl, an aminoalkyl, a polyaminoalkyl, an epoxyalkyl, especially a glycidylalkyl, a haloalkyl, a mercaptoalkyl, an alkyl sulphide or an alkyl polysulphide possibly containing a silicon atom, an azidoalkyl or a cyclic or acyclic radical containing at least one ethylenic double bond, preferably an activated ethylenic double bond.

It will be recalled that an “activated” bond is, as is well known, a bond made more reactive, in this case here capable of reacting with a diene elastomer. The ethylenic double bond (>C═C<) of the radical R is preferably activated by the presence of an adjacent electron-withdrawing group, i.e. one attached to one of the two carbon atoms of the ethylenic double bond, this electron-withdrawing group or “activating” group being especially chosen from those carrying at least one of the following bonds: C═O, C═C, C≡C, OH, O-alkyl or O-aryl, or at least one sulphur and/or nitrogen atom, or at least one halogen. By definition, an “electron-withdrawing” group is a functional group or radical capable of withdrawing electrons to itself more than would a hydrogen atom if it occupied the same place in the molecule in question.

The radicals R′, which are identical or different if there are several of them (where a=0 or 1), are especially chosen from hydrogen or an organic or organometallic radical, whether cyclic or acyclic. When R′ is an organometallic radical, it preferably comprises at least one silicon atom. Preferably, each R′ is, independently, hydrogen, an alkyl having 1 to 6 carbon atoms, an organometallic radical having 1 to 6 carbon atoms and at least one silicon atom.

The radicals R″, which are identical or different if there are several of them (with a=2), are preferably chosen from alkyls having from 1 to 6 carbon atoms, for example methyl and/or ethyl radicals.

The starting organosilane is preferably chosen from the group formed by: amino-(C₁-C₆)alkyl(C₁-C₆)alkoxysilanes, acryloxy-(C₁-C₆)alkyl(C₁-C₆)alkoxysilanes, methacryloxy-(C₁-C₆)alkyl(C₁-C₆)alkoxysilanes, glycidoxy-(C₁-C₆)alkyl(C₁-C₆)alkoxysilanes, mercapto-(C₁-C₆)alkyl(C₁-C₆)alkoxysilanes, disulphides or polysulphides of alkyl(C₁-C₂₀)—(C₁-C₆)alkoxysilanes, maleimido-alkyl(C₁-C₆)—(C₁-C₆)alkoxysilanes, isomaleimido-alkyl(C₁-C₆)—(C₁-C₆)alkoxysilanes, N—[C₁-C₆)alkyl(C₁-C₆)alkoxysilyl] maleamic acids, or a mixture of these compounds.

As particular examples of such silanes that can be used in the adhesive interphase of the composites according to the invention, mention may be made of the following: 3-aminopropyltriethoxysilane, 3-methacryloxypropyltrimethoxysilane, 3-glycidoxypropyltrimethoxysilane, 3-mercaptopropyltrimethoxysilane, N-beta-aminoethyl-3-aminopropyltrimethoxysilane, 3-aminopropyltrimethoxysilane, 3-aminoethyltriethoxysilane, 3-methacryloxypropyltriethoxysilane, 3-glycidoxyethyltriethoxysilane, 3-mercaptopropyltriethoxysilane, N-beta-aminoethyl-3-aminoethyltrimethoxysilane, 3-aminobutyltriethoxysilane, 3-aminoethyltrimethoxysilane, 3-aminopropylmethyldiethoxysilane, bis-triethoxysilylpropyl tetrasulphide, bis-trimethoxysilylpropyl tetrasulphide, 3-maleimidopropyltriethoxysilane, (N-propyltriethoxysilyl) maleamic acid.

As other particular examples of organosilanes, mention may also be made of the following: p-(trimethoxysilyl)benzyldiazoacetate, 4-(trimethoxysilyl)cyclohexylsulphonyl azide and 6-(trimethoxysilyl)hexylsulphonyl azide.

The silane is more preferably chosen from the group formed by: 3-aminopropyltriethoxysilane, N-beta-aminoethyl-3-aminopropyltrimethoxysilane, 3-glycidoxypropyltrimethoxysilane, 3-mercaptopropyltrimethoxysilane, 3-aminopropyl-methyldiethoxysilane, 3-maleimidopropyltriethoxysilane, bis-triethoxysilylpropyl tetrasulphide, and mixtures of these organosilanes.

Advantageously, an amino-(C₁-C₆)alkyl-(C₁-C₆)alkoxysilane, in particular 3-aminopropyltriethoxysilane or a maleimido-(C₁-C₆)alkyl-(C₁-C₆)alkoxysilane, in particular 3-maleimidopropyltriethoxysilane, is used.

To give an example, using an inductor comprising two turns, with an acting length of 10 mm and an rms power of 1000 W, through which a metal thread 0.8 mm in diameter runs at a speed of 300 m/min, coated with a solution comprising a silane diluted to 5% in water.

The temperature of the thread is raised to about 170° C. A film of silane is deposited, with a thickness at all points on the surface of the thread of between 10 and 100 nm, preferably between 30 and 50 nm. This thickness is uniform, there being no overthickness nor any meniscus.

The thickness of the film therefore remains, at all points on the surface of the thread, smaller than the thickness of a meniscus, which may vary, as seen above, from 1 μm to 30 μm. This thickness of the silane film is even very much less than 0.1 μm.

FIG. 4 illustrates the case of a thread 4 comprising three elementary filaments 41, the diameter of which corresponds to the diameters of threads widely used in the tyre industry, which may vary from 0.05 mm to 0.3 mm. The thread 4 is coated with a film 31, the thickness of which is substantially constant over the entire surface of the thread, there being no inter-filament menisci.

Trials carried out with a solution containing latex, as an emulsion in water, have also given good results.

1. A method of depositing a solute on a metal thread, comprising the steps of:
depositing a liquid solution, formed from a volatile solvent and said solute, on the thread; and then
rapidly raising the temperature of the thread to a temperature above the vaporization temperature of the solvent so as to vaporize the solvent placed in contact with the surface of said thread and to form vapour bubbles which, by expanding, generate a pressure pulse that ejects the liquid remaining on the periphery of the thread.

2. The method according to claim 1, wherein the temperature of the metal thread is raised by means of a high-frequency electric induction heater.

3. The method according to claim 2, wherein, for a given solute concentration in the solvent, the amount of solute deposited on the thread is inversely proportional to the power dissipated by the heater.

4. The method according to claim 3, wherein the amount of solute deposited on the thread is regulated by varying the power dissipated by the heating system.

5. The method according to claim 1, wherein the liquid solution is brought to a temperature slightly below the vaporization temperature of the solvent during the step of depositing the liquid solution on the thread.

6. The method according to claim 1, wherein the liquid solution is formed from a silane mixed with water.
